(19) United States
(12) Patent Application Publication
(10) Pub. No.: US 2022/0336810 A1
(43) Pub. Date: Oct. 20, 2022

(54) Anode for Lithium Secondary Battery, Lithium Secondary Battery Including the Same and Method of Fabricating the Same

(71) Applicant: SK ON CO., LTD., Seoul (KR)

(72) Inventors: Hae Suk Hwang, Daejeon (KR); Mi Ryeong Lee, Daejeon (KR); Hee Gyoung Kang, Daejeon (KR); Jong Hyuk Lee, Daejeon (KR)

(21) Appl. No.: 17/723,796

(22) Filed: Apr. 19, 2022

(30) Foreign Application Priority Data
Apr. 19, 2021 (KR) 10-2021-0050337

(51) Int. Cl. H01M 4/587; H01M 10/0525; H01M 4/485; H01M 4/04; H01M 4/1393; H01M 4/36

(52) U.S. Cl. CPC H01M 4/587; H01M 10/0525; H01M 4/485; H01M 4/0404; H01M 4/1393; H01M 4/366; H01M 2004/021

(57) ABSTRACT

An anode for a lithium secondary battery according to an embodiment of the present invention includes a current collector, and an anode active material layer coated on the current collector. The anode active material layer includes an anode active material that includes natural graphite particles, and has an electrode density of 1.50 g/cc or more. An XRD orientation index defined as I(004)/I(110) is 8 or less, I(004) is a peak intensity corresponding to a (004) plane of the anode active material obtained by an XRD measurement from the anode active material layer, and I(110) is a peak intensity corresponding to a (110) plane of the anode active material obtained by the XRD measurement from the anode active material layer.

### CROSS-REFERENCE TO RELATED APPLICATION

This application claims priority to Korean Patent Application No. 10-2021-0050337 filed on Apr. 19, 2021, the disclosure of which is hereby incorporated by reference in its entirety.

### BACKGROUND OF THE INVENTION

### 1. Field of the Invention

The present invention relates to an anode for a lithium secondary battery, a lithium secondary battery including the same, and a method of fabricating the same. More particularly, the present invention relates to an anode including natural graphite as an anode active material for a lithium secondary battery, a lithium secondary battery including the same and a method of fabricating the same.

### 2. Description of Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as a hybrid automobile.

The secondary battery includes, e.g., a lithium secondary battery, a nickel-cadmium battery, a nickel-hydrogen battery, etc. The lithium secondary battery is highlighted due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape.

An amorphous carbon or a crystalline carbon may be used as an anode active material, and the crystalline carbon is mainly used because of high capacity. Examples of the crystalline carbon include natural graphite, artificial graphite, etc.

Natural graphite may be advantageous from aspects of high capacity and low cost. However, natural graphite may have an irregular structure, and may cause a swelling due to an electrolyte decomposition reaction occurring at an edge portion thereof to result in reduction of charging and discharging efficiency and capacity. For example, researches to resolve the above-mentioned issues through a spheroidization treatment and a surface coating treatment of natural graphite are being conducted.

For example, Korean Registered Patent Publication No. 10-1249349 discloses an anode active material including natural graphite.

### SUMMARY OF THE INVENTION

According to an aspect of the present invention, there is provided an anode for a lithium secondary battery having improved stability and reliability.

According to an aspect of the present invention, there is provided a method of fabricating an anode for a lithium secondary battery having improved stability and reliability.

According to an aspect of the present invention, there is provided a lithium secondary battery having improved stability and reliability.

An anode for a lithium secondary battery according to embodiments includes a current collector, and an anode active material layer coated on the current collector. The anode active material layer includes an anode active material that includes natural graphite particles and having an electrode density of 1.50 g/cc or more. An XRD orientation index defined as I(004)/I(110) is 8 or less, I(004) is a peak intensity corresponding to a (004) plane of the anode active material obtained by an XRD measurement from the anode active material layer, and I(110) is a peak intensity corresponding to a (110) plane of the anode active material obtained by the XRD measurement from the anode active material layer.

In some embodiments, the XRD orientation index may be in a range from 2 to 8.

In some embodiments, the electrode density of the anode active material layer may be in a range from 1.50 g/cc to 1.80 g/cc.

In some embodiments, the electrode density of the anode active material layer may be in a range from 1.70 g/cc to 1.80 g/cc.

In some embodiments, a sphericity of the natural graphite particles may be in a range from 0.88 to 0.99.

In some embodiments, the anode active material may further include an amorphous carbon layer formed on the natural graphite particles.

In some embodiments, a weight ratio of the amorphous carbon layer relative to a weight of the natural graphite particles may be in a range from 1 wt % to 10 wt %.

In some embodiments, a porosity of the natural graphite particles measured by a nitrogen adsorption method may be in a range from 0.01 g/cm³ to 0.03 g/cm³.

A lithium secondary battery according to embodiments of the present invention includes a cathode including lithium-transition metal composite oxide particles as a cathode active material, and the anode for a lithium secondary battery according to embodiments as described above facing the cathode.

In a method of fabricating an anode for a lithium secondary battery according to embodiments of the present invention, an anode slurry that includes an anode active material including natural graphite particles is prepared. A preliminary anode active material layer is formed by coating and drying the anode slurry on a current collector. The preliminary anode active material layer is pressed to form an anode active material layer having an electrode density of 1.50 g/cc or more. A difference between the XRD orientation indexes of the anode active material layer and the preliminary anode active material layer is 6 or less. The XRD orientation index is defined as I(004)/I(110), I(004) is a peak intensity corresponding to a (004) plane of the anode active material obtained by an XRD measurement, and I(110) is a peak intensity corresponding to a (110) plane of the anode active material obtained by the XRD measurement.

In some embodiments, the XRD orientation index of the anode active material layer may be 8 or less.

In some embodiments, the XRD orientation index of the preliminary anode active material layer may be 2 or more.

In some embodiments, the electrode density of the anode active material layer is may be in a range from 1.50 g/cc to 1.80 g/cc.

In some embodiments, the electrode density of the anode active material layer may be in a range from 1.70 g/cc to 1.80 g/cc.

In some embodiments, a sphericity of the natural graphite particles may be in a range from 0.88 to 0.99.

In some embodiments, in the preparing the anode slurry, an amorphous carbon layer may be formed on surfaces of the natural graphite particles.

An anode of a lithium secondary battery according to embodiments of the present invention may include natural graphite having an amorphous coating formed thereon, and may have an XRD orientation index (I004/I110) in a predetermined range and an electrode density of 1.50 g/cc or more. Accordingly, an electrolyte wet-ability may be improved and enhanced fast charging properties may be provided.

According to exemplary embodiments, a difference between an XRD orientation index measured after forming an anode active material layer to have an electrode density of 1.50 g/cc or more and an XRD orientation index of a preliminary anode active material layer may be 6 or less. Accordingly, even when the electrode is formed to have high density, deformation of active material particles may be suppressed, and electrolyte wet-ability, life-span and high-temperature storage properties may be improved.

### BRIEF DESCRIPTION OF THE DRAWINGS

FIGS. 1 and 2 are a schematic cross-sectional view and a schematic top planar view, respectively, illustrating a lithium secondary battery in accordance with exemplary embodiments.

FIG. 3 is a schematic flow diagram for describing a method of fabricating an anode for a lithium secondary battery in accordance with exemplary embodiments.

FIG. 4 is a graph showing a change of an XRD orientation index (I004/I110) according to anode densities in Example 1 and Comparative Examples 1 and 2.

### DESCRIPTION OF THE INVENTION

According to exemplary embodiments of the present invention, an anode for a lithium secondary battery which includes an anode active material having an electrode density, an XRD orientation property and a sphericity within predetermined ranges, and provides improved cost-efficiency, life-span and high-temperature properties is provided.

According to exemplary embodiments of the present invention, a method of fabricating the anode and a lithium secondary battery including the anode are also provided.

Hereinafter, the present invention will be described in detail with reference to exemplary embodiments and the accompanying drawings. However, those skilled in the art will appreciate that such embodiments described with reference to the accompanying drawings are provided to further understand the spirit of the present invention and do not limit subject matters to be protected as disclosed in the detailed description and appended claims.

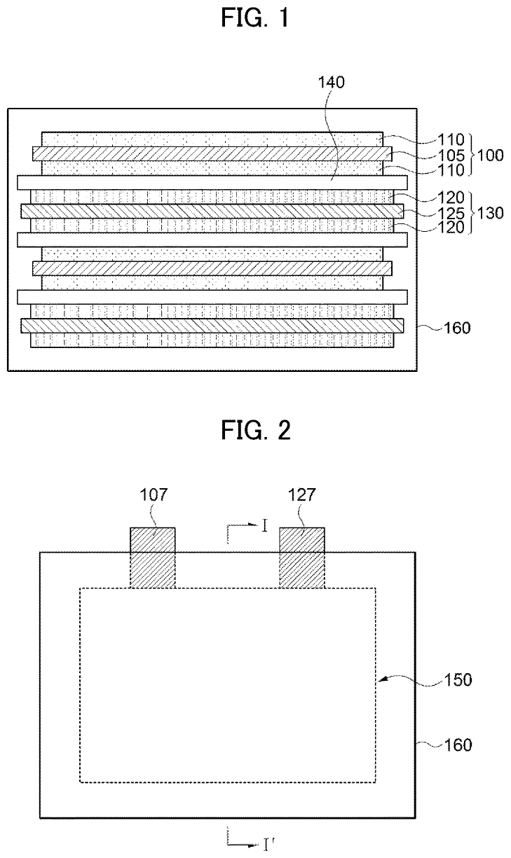

FIGS. 1 and 2 are a schematic cross-sectional view and a schematic top planar view, respectively, illustrating a lithium secondary battery in accordance with exemplary embodiments. For example, FIG. 1 is a cross-sectional view taken along a line I-I′ of FIG. 2 in a thickness direction.

Hereinafter, detailed descriptions of an anode for a lithium secondary battery and a lithium secondary battery including the same are provided together with reference to FIGS. 1 and 2.

Referring to FIGS. 1 and 2, the lithium secondary battery may include an electrode assembly including a cathode 100, an anode 130 and a separation layer 140 interposed between the cathode and the anode.

The anode 130 may include an anode current collector 125 and an anode active material layer 120 formed by coating an anode active material on the anode current collector 125.

In exemplary embodiments, a carbon-based material may be used as the anode active material. In a preferable embodiment, natural graphite may be used as the anode active material

For example, natural graphite has an exposed edge surface, and an electrolyte decomposition reaction may occur at the edge surface to lower an electrolyte wet-ability and degrade charge/discharge efficiency. Further, natural graphite may be expanded during repeated charging/discharging, which may cause damages to particles or crystal structures, and natural graphite may have chemical and mechanical stability or durability less than those of artificial graphite.

However, natural graphite may have improved power/capacity properties relatively with lower cost. Thus, for example, high-capacity properties may be implemented from each of the cathode and the anode of the lithium secondary battery in combination with a high-nickel (High-Ni) cathode composition.

In some embodiments, the anode active material may include a natural graphite particle provided as an active material core and an amorphous carbon layer formed on a surface of natural graphite.

The amorphous carbon layer may include, e.g., a carbon-based material such as a coal-based material or a petroleum-derived material, which may have a crystallinity less than that of a graphite-based material or may be substantially amorphous. In an embodiment, a thickness of the amorphous carbon layer may be from 50 nm to 500 nm.

For example, the amorphous carbon layer may fill pores on the surface of natural graphite particle to reduce a specific surface area and reduce a decomposition reaction site of the electrolyte. Accordingly, a hardness of the natural graphite particle, an anode density and an anode orientation property may be improved. Further, an anode performance deterioration due to excessive activity and expansion on the surface of the natural graphite particle may be suppressed.

In an embodiment, the amorphous carbon layer may serve as a coating layer uniformly covering an entire surface of the natural graphite particle. In an embodiment, the amorphous carbon layer may be formed on the surface of the natural graphite particle in the form of, e.g., an island-shaped layer or pattern to partially cover the surface of the natural graphite particle.

In some embodiments, the natural graphite particle may be sphere-treated. For example, a plate-shaped graphite may be pulverized through an impact blending or a milling. Thereafter, the pulverized graphite powder may be acid-treated using HF, HCl, HNO₃, or the like, and then washed with water. The acid-treated and washed fine particles may be converted into spherical particles through a pressing process.

For example, a sphericity of the natural graphite particles may be 0.88 or more, preferably from 0.90 to 0.99. In the above range, for example, even when manufacturing a high-density electrode of 1.50 g/cc or more, 1.60 g/cc or more or 1.70 g/cc or more, the anode materials may be prevented from being excessively pressed, so that the orientation property of the anode may be improved. Additionally, the electrolyte wet-ability and rapid charging/discharging properties of the electrode may be enhanced.

The term “sphericity” used herein may be defined as (a perimeter of an equivalent circle having the same area as that of a projection of the natural graphite particle)/(an actual perimeter of the projection of the natural graphite particle).

The sphere-treated natural graphite particles may be used so that the amorphous carbon layer having a uniform thickness may be easily formed, and an expansion of the anode may be more effectively suppressed. Further, a specific surface area of the natural graphite particle may be reduced by the amorphous carbon layer, thereby improving the life-span properties of the anode active material.

The natural graphite particles may be mixed with an amorphous carbon material such as pitch or tar, and then, e.g., a heat treatment at a temperature range from 1,000° C. to 2,000° C. to obtain the natural graphite particles having the amorphous carbon layer such as a carbide layer.

In some embodiments, the amorphous carbon layer may include a carbonized organic material. The carbonized organic material may be formed from, e.g., citric acid, stearic acid, sucrose, polyvinylidene fluoride, carboxymethyl cellulose, hydroxypropyl cellulose, regenerated cellulose, polyvinylpyrrolidone, polyethylene, polypropylene, an ethylene-propylene-diene monomer (EPDM), polyacrylic acid, polyacrylonitrile, glucose, gelatin, a phenolic resin, a naphthalene-based resin, a polyamide-based resin, a furan-based resin, a polyvinyl alcohol-based resin, a polyimide-based resin, a cellulose-based resin, a styrene-based resin, an epoxy-based resin, etc.

In an embodiment, an amount of the amorphous carbon layer may be in a range from about 1 weight percent (wt %) to 10 wt % based on a weight of the active material core (e.g., the natural graphite particle). In the above range, an expansion stability may be improved without excessively inhibiting an activity of the active material core. Preferably, the amount of the amorphous coating layer may be from about 2 wt % to 9 wt % based on the weight of the active material core (e.g., the natural graphite particle).

In some embodiments, an average particle diameter (D₅₀) of the natural graphite particles may be in a range from about 5 μm to 15 μm. The average particle diameter (D₅₀) refers to a particle diameter at 50 vol % in a cumulative volumetric particle size distribution. In the particle diameter range, voids in the anode 130 may be properly controlled, so that an expansion ratio of the anode may be easily suppressed.

In some embodiments, the natural graphite particle may have a porosity (a total pore volume ratio) in a range from 0.01 cm³/g to 0.03 cm³/g. The natural graphite particle having the porosity within the above range may be used, so that particle cracks caused by repeated charging and discharging of the anode active material may be prevented while maintaining high capacity/activity for a long period. For example, if the porosity of the natural graphite particle is excessively small, a buffer space may not be sufficiently provided during repeated contraction/expansion of the anode, which may cause particle damages.

In a preferable embodiment, the porosity of the natural graphite particle may be in a range from 0.01 cm³/g to 0.02 cm³/g, preferably from 0.01 cm³/g to 0.0195 cm³/g.

The porosity of the natural graphite particle may be measured through a nitrogen adsorption method. For example, the porosity may be measured by measuring an amount of a nitrogen adsorption and a desorption after filling the natural graphite particles in a measurement cell of a BET equipment.

In some embodiments, a slurry may be prepared by mixing and stirring the above-described anode active material with a binder, a conductive material and/or a dispersive agent in a solvent. The slurry may be coated on at least one surface of the anode current collector 125, dried and pressed to form the anode active material layer 120.

The binder may enhance adhesion between the anode active material particles or between the anode active material particles and the anode current collector 125. A water-insoluble binder, a water-soluble binder or a combination thereof may be used as the binder.

In some embodiments, an amount of the binder may be 3 wt % or less of a total weight of the anode active material layer 120.

Examples of the water-insoluble binder include polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, polyamideimide, polyimide or a combination thereof.

Examples of the water-soluble binder include styrene-butadiene rubber, acrylated styrene-butadiene rubber, polyvinyl alcohol, sodium polyacrylate, a copolymer of propylene and an olefin having 2 to 8 carbon atoms, a copolymer of (meth)acrylic acid and (meth)acrylic acid alkyl ester, or a combination thereof.

The water-soluble binder may be used together with a cellulose-based compound as a thickener. The cellulose-based compound may include carboxymethyl cellulose, hydroxypropylmethyl cellulose, methyl cellulose, or an alkali metal salt thereof. The alkali metal may include Na, K or Li.

The conductive material may be included to promote an electron mobility between the active material particles. For example, the conductive material may include a carbon-based material such as natural graphite, artificial graphite, carbon black, acetylene black, Ketjen black, carbon fiber or carbon nanotube; a metal-based material such as a metal powder of, e.g., copper, nickel, aluminum, silver, etc., or a metal fiber; a conductive polymer such as a polyphenylene derivative; or a mixture thereof.

The anode current collector 125 may include a copper foil, a nickel foil, a stainless steel foil, a titanium foil, a nickel foam, a copper foam, a polymer substrate coated with a conductive metal, or a combination thereof.

In exemplary embodiments, an XRD orientation index measured on a surface of the anode active material layer 120 may be 8 or less.

The term “XRD orientation index” used herein may refer to I(004)/I(110). I(004) is a peak intensity or a maximum height of a peak corresponding to a (004) plane measured from an X-ray diffraction graph. I(110) is a peak intensity or a maximum height of a peak corresponding to a (110) plane measured from the X-ray diffraction graph.

The XRD orientation index may indicate a crystallinity of the natural graphite particle or the active material core. If the XRD orientation index is excessively small, exposure of an active surface of the active material core may be increased to degrade the life-span properties or the rapid charging/discharging properties of the anode 130 or the secondary battery.

In a preferable embodiment, the XRD orientation index may be adjusted in a range from 2 to 8 in consideration of a capacity and an energy density from the anode active material layer 120.

In exemplary embodiments, an electrode density of the anode active material layer 120 may be 1.50 g/cc or more. Preferably, the electrode density of the anode active material layer 120 may be 1.60 g/cc or more, or 1.70 g/cc or more. In an embodiment, the electrode density of the anode active material layer 120 may be 1.80 g/cc or less.

Preferably, the electrode density of the anode active material layer 120 may be from 1.50 g/cc to 1.80 g/cc, more preferably from 1.70 g/cc to 1.80 g/cc. For example, if the electrode density of the anode active material layer 120 exceeds 1.80 g/cc, the anode active material particles may be damaged or a sphericity may be lowered by the pressing process. Accordingly, the active material core may be excessively exposed to degrade the life-span properties. If the electrode density of the anode active material layer 120 is less than 1.50 g/cc, the energy density from the anode 130 may be decreased, and sufficient capacity may not be provided.

The anode active material layer 120 may formed to have the above-described ranges of the electrode density range and the XRD orientation index, so that sufficient life-span stability and capacity retention may be achieved even when using the natural graphite particles that may have relatively low chemical and mechanical stability.

The cathode 100 may include a cathode active material layer 110 formed by coating a cathode active material on the cathode current collector 105. The cathode active material may include a compound capable of reversibly intercalating and de-intercalating lithium ions.

In exemplary embodiments, the cathode active material may include a lithium-transition metal composite oxide particle. For example, the lithium-transition metal composite oxide particle may include nickel (Ni), and may further include at least one of cobalt (Co) and manganese (Mn).

For example, the lithium-transition metal composite oxide particle may be represented by Chemical Formula 1 below.

LiₓNi_{1-y}M_{y}O_{2+z} [Chemical Formula 1]

In Chemical Formula 1, 0.9≤x≤1.1, 0≤y≤0.7, and −0.1≤z≤0.1. M may include at least one element selected from the group consisting of Na, Mg, Ca, Y, Ti, Zr, Hf, V, Nb, Ta, Cr, Mo, W, Mn, Co, Fe, Cu, Ag, Zn, B, Al, Ga, C, Si, Sn and Zr.

In some embodiments, a molar ratio or a concentration (1-y) of Ni in Chemical Formula 1 may be 0.8 or more, and may preferably exceed 0.8.

Ni may serve as a transition metal related to power and capacity of the lithium secondary battery. Therefore, as described above, the high-Ni composition in the lithium-transition metal composite oxide particle may be employed, so that a high-capacity cathode and a high-capacity lithium secondary battery may be implemented.

However, as the content of Ni increases, long-term storage stability and life-span stability of the cathode or the secondary battery may be relatively deteriorated. In exemplary embodiments, life-span stability and capacity retention properties may be improved by the introduction of Mn while maintaining an electrical conductivity by including Co.

In some embodiments, the cathode active material or the lithium-transition metal composite oxide particle may further include a coating element or a doping element. For example, the coating element or doping element may include Al, Ti, Ba, Zr, Si, B, Mg, P, W, V, an alloy thereof, or an oxide thereof. These may be used alone or in combination thereof. The cathode active material particle may be passivated by the coating or doping element, thereby further improving stability and life-span even when a penetration of an external object occurs.

A slurry may be prepared by mixing and stirring the cathode active material with a binder, a conductive material and/or a dispersive agent in a solvent. The slurry may be coated on the cathode current collector 105, dried and pressed to form the cathode 100.

The cathode current collector 105 may include, e.g., stainless steel, nickel, aluminum, titanium, copper or an alloy thereof, preferably may include aluminum or an aluminum alloy.

The binder and the conductive material may include materials substantially the same as or similar to those used in the anode. For example, a PVDF-based binder may be used as a cathode binder.

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

In some embodiments, an area and/or a volume of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation.

In exemplary embodiments, an electrode cell may be defined by the cathode 100, the anode 130 and the separation layer 140, and a plurality of the electrode cells may be stacked to form an electrode assembly 150 that may have e.g., a jelly roll shape. For example, the electrode assembly 150 may be formed by winding, laminating or folding the separation layer 140.

The electrode assembly 150 may be accommodated together with an electrolyte in a case 160 to define the lithium secondary battery. In exemplary embodiments, a non-aqueous electrolyte may be used as the electrolyte.

For example, the non-aqueous electrolyte may include a lithium salt and an organic solvent. The lithium salt may be represented by Li⁺X⁻. An anion of the lithium salt X⁻ may include, e.g., F⁻, CI⁻, Br⁻, I⁻, NO₃⁻, N(CN)₂⁻, BF₄, ClO₄⁻, PF₆⁻, (CF₃)₂PF₄⁻, (CF₃)₃PF₃⁻, CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination thereof.

As illustrated in FIG. 2, an electrode tab (a cathode tab and an anode tab) may be formed from each of the cathode current collector 105 and the anode current collector 125 to extend to one end of the case 160. The electrode tabs may be welded together with the one end of the case 160 to form an electrode lead (a cathode lead 107 and an anode lead 127) exposed at an outside of the case 160.

FIG. 2 illustrates that the cathode lead 107 and the anode lead 127 protrude from an upper side of the case 160 in a planar view, but locations of the electrode leads are not limited as illustrated in FIG. 2. For example, the electrode leads may protrude from at least one of both lateral sides of the case 160, or may protrude from a lower side of the case 160. Alternatively, the cathode lead 107 and the anode lead 127 may be formed to protrude from different sides of the case 160.

The lithium secondary battery may be fabricated into a cylindrical shape using a can, a prismatic shape, a pouch shape, a coin shape, etc.

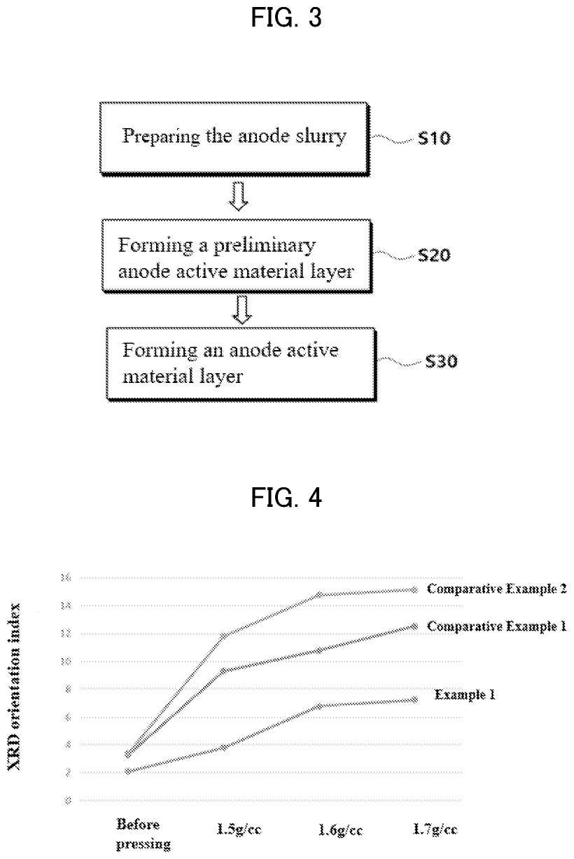

FIG. 3 is a schematic flow diagram for describing a method of fabricating an anode for a lithium secondary battery in accordance with exemplary embodiments.

Referring to FIG. 3. an anode slurry including natural graphite particles as an anode active material may be prepared (in an operation of S10).

As described above, the sphericity of the natural graphite particles may be 0.88 or more, preferably from 0.90 to 0.99. In the above range, for example, even when manufacturing a high-density electrode of 1.50 g/cc or more, the anode materials may be prevented from being excessively pressed, so that the orientation property of the anode may be improved. Additionally, the electrolyte wet-ability and rapid charging/discharging properties of the electrode may be enhanced.

If the sphericity is less than 0.88, the orientation index of the anode may be decreased when pressing to a high density during the fabrication of the anode to degrade the electrode density and the energy density per a unit volume. Thus, the sphericity of the natural graphite particles may be adjusted in a range from 0.88 to 0.99, the electrolyte wet-ability and rapid charging/discharging properties may be improved even when fabricating the anode having the high density of 1.50 g/cc or more.

As described above, the anode active material may be prepared by forming the amorphous carbon layer on the surface of the natural graphite particles. An anode slurry may be prepared by mixing the anode active material, the binder and the conductive material.

The anode slurry may be coated on the current collector 125 and dried to form a preliminary anode active material layer (in an operation of S20). Thereafter, an XRD orientation index may be measured from a surface of the preliminary anode active material layer. In some embodiments, the XRD orientation index of the preliminary anode active material layer may be 2 or more.

In exemplary embodiments, the anode active material layer 120 having an electrode density of 1.50 g/cc or more may be formed by pressing the preliminary anode active material layer (in an operation of S30). An XRD orientation index of the anode active material layer 120 may be 8 or less.

In a preferable embodiment, the XRD orientation index may be adjusted in a range from 2 to 8 in consideration of the capacity and the energy density of the anode active material layer 120.

In exemplary embodiments, a difference between the XRD orientation indexes of the anode active material layer 120 and the preliminary anode active material layer may be 6 or less. As described above, the XRD orientation index is represented as I(004)/I(110) which is a ratio of a peak intensity of a (110) plane of the anode active material relative to a peak intensity of a (004) plane of the anode active material obtained by an XRD measurement.

As the difference in the XRD orientation indexes becomes small, a particle deformation and an influence of the electrode orientation before and after the pressing may become small. When the XRD orientation index difference before and after the pressing of the anode active material layer 120 is 6 or less, exposure of an active surface of the active material core may be effectively suppressed. Thus, the electrolyte wet-ability of the anode 130 may be improved, and enhanced life-span and storage properties may be provided during rapid charging/discharging.

A porosity measured by a nitrogen adsorption method of the natural graphite particles may be in a range from 0.01 g/cm³ to 0.03 g/cm³.

As described above, the electrode density of the anode active material layer 120 may be 1.50 g/cc or more. Preferably, the electrode density of the anode active material layer 120 may be 1.60 g/cc or more, or 1.70 g/cc or more. In an embodiment, the electrode density of the anode active material layer 120 may be 1.80 g/cc or less.

Preferably, the electrode density of the anode active material layer 120 may be from 1.50 g/cc to 1.80 g/cc, more preferably from 1.70 g/cc to 1.80 g/cc.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### EXAMPLES AND COMPARATIVE EXAMPLES

Preparation of Secondary Battery

Anode

Natural graphite particles shown in Table 2 were prepared as an anode active material, and a binder was prepared by mixing styrene-butadiene rubber (SBR) as an aqueous binder and carboxymethyl cellulose (CMC) as a thickener in a weight ratio of 1.2:1.5. A plate-shaped conductive material was prepared.

The anode active material, the binder and the conductive material were mixed in a weight ratio of 94:3:3, and then dispersed in water to prepare an anode slurry. The anode slurry was coated on a copper foil having a thickness of 8 μm, dried in an oven at 80° C. for 2 hours, and pressed so that a density of the anode active material layer was 1.7 g/cc, and further dried in a vacuum oven at 110° C. for 12 hours to prepare an anode for a secondary battery.

A coin half-cell (CR2016) was fabricated by a method widely known in the related art using the anode, a lithium foil as a counter electrode, a porous polyethylene separator, and an electrolyte. 1M LiPF6 solution using a solvent including ethylene carbonate (EC)/ethyl methyl carbonate (EMC)/diethyl carbonate (DEC)/fluoroethylene carbonate (FEC) mixed in a volume ratio of 2/2/5/1 was used as the electrolyte.

Cathode

LiNi_{0.8}Co_{0.1}Mn_{0.1}O₂ (average particle diameter (D50)=12 μm) as a cathode active material, Denka Black, KS6 flake-shaped graphite-based conductive material, and PVDF as a binder were mixed in a mass ratio of 96.5:1:1:1.5 to prepare a cathode slurry. The cathode slurry was coated on an aluminum substrate having a thickness of 12 μm, dried and pressed to prepare a cathode.

<Secondary Battery>

A secondary battery cell having a capacity of about 20 Ah was fabricated as follows using the cathode and anode prepared as described above.

The cathode and the anode prepared as described above were each notched with a predetermined size, and stacked with a separator (polyethylene, thickness: 13 μm) interposed between the cathode and the anode to form a battery cell, and each tab portion of the cathode and the anode was welded. The welded cathode/separator/anode assembly was inserted in a pouch, and three sides of the pouch except for an electrolyte injection side were sealed. The tab portions were also included in sealed portions. An electrolyte was injected through the electrolyte injection side, and then the electrolyte injection side was also sealed. Subsequently, the above structure was impregnated for more than 24 hours to obtain the secondary battery cell.

The electrolyte was prepared by forming 1M LiPF₆ solution in a mixed solvent of ethylene carbonate (EC)/ethyl methyl carbonate (EMC)/diethylene carbonate (DEC) (25/45/30; volume ratio), and then adding 7 wt % of fluoroethylene carbonate (FEC), 0.5 wt % of 1,3-propensultone (PRS), 0.5 wt % of lithium bis(oxalato)borate (LiBOB) and 0.5 wt % of ethylene sulfate (ESA).

### Experimental Example

(1) Measurement of XRD Orientation Index

An XRD analysis was performed using a Cu Kα ray as a diffraction light source at a scan rate of 0.0065% in a diffraction angle (2θ) range from 10° to 120°. Specifically, conditions of the XRD analysis are shown in Table 1 below.

TABLE 1
XRD(X-Ray Diffractometer(X'pert)

| | |
|---|---|
| Maker | Rigaku |
| Anode material | Cu |
| K-Alpha1 wavelength | 1.540598 Å |
| Generator voltage | 45 kV |
| Tube current | 40 mA |
| Scan Range | 10~120° |
| Scan Step Size | 0.0065° |
| Divergence slit | ¼° |
| Antiscatter slit | ½° |

(2) Measurement of Initial Discharge Capacity and Initial Discharge Efficiency

A constant current was applied until the battery voltage reached 0.01V (vs. Li) at a current of 0.1 C rate and 25° C., and then a constant voltage was applied for charging until the current reached 0.01 C rate. Discharging was performed at a constant current of 0.1 C rate until the voltage reached 1.5V (vs. Li).

(3) Measurement of Life-Span Properties (Capacity Retention After 100 Cycles)

Evaluation on life-span of the secondary battery cells having the capacity of about 20 Ah manufactured according to Examples and Comparative Examples was performed in a chamber maintained at a constant temperature (25° C.) within the range of DOD100 at 2C charge/2C discharge c-rate.

(4) Measurement of Storage Properties (Capacity Retention)

The secondary battery cells having the capacity of about 20 Ah prepared according to Examples and Comparative Examples were set to SOC100 at 0.5 C charging c-rate, and then storage evaluation was performed in a chamber maintained at a constant temperature (60° C.). The battery cells were taken out from the chamber at an interval of 4 weeks and cooled to room temperature, and then a capacity was measured at 0.5 C discharge C-rate. Thereafter, the SOC100 state was set again and stored in a chamber maintained at a constant temperature (60° C.).

### Evaluation Example

### (1) Evaluation Example 1

As shown in Table 2 below, the secondary battery cells were prepared as described above using the natural graphite particles having different XRD orientation indices, electrode densities and sphericity values, and battery performance properties s were measured as shown in Table 3 below.

TABLE 2

| | XRD orientation | | Electrode |
|---|---|---|---|
| | index | | density |
| | I(004)/I(110) | Sphericity | (g/cc) |
| Example 1 | 3.0 | 0.93 | 1.70 |
| Example 2 | 2.5 | 0.94 | 1.70 |
| Example 3 | 4.6 | 0.95 | 1.80 |
| Example 4 | 8.0 | 0.88 | 1.50 |
| Example 5 | 2.3 | 0.96 | 1.80 |
| Example 6 | 7.0 | 0.91 | 1.70 |
| Comparative | 12.5 | 0.87 | 1.70 |
| Example 1 | | | |
| Comparative | 15.1 | 0.96 | 1.70 |
| Example 2 | | | |

TABLE 3

| | Initial | Life-span | High temperature |
|---|---|---|---|
| | Efficiency | property | storage property |
| | (%) | (%) | (%) |
| Example 1 | 91.4 | 94 | 90.4 |
| Example 2 | 90.5 | 95 | 90.1 |
| Example 3 | 90.1 | 93 | 90.6 |
| Example 4 | 88.9 | 90 | 88.7 |
| Example 5 | 90.0 | 96 | 91.0 |
| Example 6 | 89.9 | 92 | 90.4 |
| Comparative | 88.5 | 91 | 88.1 |
| Example 1 | | | |
| Comparative | 88.2 | 90 | 88.6 |
| Example 2 | | | |

Referring to the results in Table 3, in Examples where the XRD orientation index was 8 or less, the sphericity was 0.88 or more, and the electrode density was 1.50 g/cc or more, improved initial efficiency, life-span and high temperature storage properties were obtained. Further, in the case that the XRD orientation index was from 2 to 8, the sphericity was from 0.90 to 0.99, and the electrode density was 1.70 g/cc to 1.80 g/cc, more enhanced battery performance properties were obtained.

### (2) Evaluation Example 2

The XRD orientation index according to the electrode density was measured using the anode active materials of Example 1 and Comparative Examples 1 and 2 as shown in Table 4 below, and a difference in the XRD orientation indexed before and after the pressing was also calculated. Further, the battery performance properties were measured as shown Table 5 below.

TABLE 4

| | XRD orientation index (I(004)/I(110)) | | | | | |
|---|---|---|---|---|---|---|
| | | | | | | Difference |
| | | | | | | of XRD |
| | Before | 1.50 | 1.60 | 1.70 | 1.80 | orientation |
| | pressing | g/cc | g/cc | g/cc | g/cc | indexes |
| Example 1 | 2.1 | 3.8 | 6.8 | 7.2 | 8.0 | 5.1 |
| Comparative | 3.3 | 9.3 | 10.8 | 12.5 | 14.5 | 9.2 |
| Example 1 | | | | | | |
| Comparative | 3.4 | 11.8 | 14.8 | 15.1 | 17.6 | 11.7 |
| Example 2 | | | | | | |

TABLE 5

| | | | | High |
|---|---|---|---|---|
| | Difference | | | temperature |
| | of XRD | Initial | Life-span | storage |
| | orientation | Discharge | property | property |
| | indexes | Capacity | (%) | (%) |
| Example 1 | 5.1 | 90.1 | 97 | 90.4 |
| Comparative | 9.2 | 88.5 | 91 | 88.1 |
| Example 1 | | | | |
| Comparative | 11.7 | 88.2 | 90 | 88.6 |
| Example 2 | | | | |

The difference of the XRD orientation indexed in Table 4 refers to a difference between the XRD orientation index at the electrode density of 1.7 g/cc and the XRD orientation index before the pressing.

Referring to Table 4 and FIG. 4, in Example 1 where the difference in the XRD orientation indexed was adjusted to 6 or less, the life-span and high temperature storage properties characteristics were improved compared to those from Comparative Examples 1 and 2.

For example, in Example 1, it is predicted that deformation of the active material particle and the electrode orientation influence were suppressed so that the electrolytic wet-ability and the rapid charge/discharge properties were improved.

What is claimed is:

1. An anode for a lithium secondary battery, comprising
a current collector; and
an anode active material layer coated on the current collector, the anode active material layer comprising an anode active material that comprises natural graphite particles and having an electrode density of 1.50 g/cc or more,
wherein an XRD orientation index defined as I(004)/I(110) is 8 or less,
I(004) is a peak intensity corresponding to a (004) plane of the anode active material obtained by an XRD measurement from the anode active material layer, and
I(110) is a peak intensity corresponding to a (110) plane of the anode active material obtained by the XRD measurement from the anode active material layer.

2. The anode for a lithium secondary battery of claim 1, wherein the XRD orientation index is in a range from 2 to 8.

3. The anode for a lithium secondary battery of claim 1, wherein the electrode density of the anode active material layer is in a range from 1.50 g/cc to 1.80 g/cc.

4. The anode for a lithium secondary battery of claim 1, wherein the electrode density of the anode active material layer is in a range from 1.70 g/cc to 1.80 g/cc.

5. The anode for a lithium secondary battery of claim 1, wherein a sphericity of the natural graphite particles is in a range from 0.88 to 0.99.

6. The anode for a lithium secondary battery of claim 1, wherein the anode active material further comprises an amorphous carbon layer formed on the natural graphite particles.

7. The anode for a lithium secondary battery of claim 6, wherein a weight ratio of the amorphous carbon layer relative to a weight of the natural graphite particles is in a range from 1 wt % to 10 wt %.

8. The anode for a lithium secondary battery of claim 1, wherein a porosity of the natural graphite particles measured by a nitrogen adsorption method is in a range from 0.01 g/cm³ to 0.03 g/cm³.

9. A lithium secondary battery, comprising
a cathode comprising lithium-transition metal composite oxide particles as a cathode active material; and
the anode for a lithium secondary battery of claim 1 facing the cathode.

10. A method of fabricating an anode for a lithium secondary battery, comprising the steps of:
preparing an anode slurry that comprises an anode active material comprising natural graphite particles;
forming a preliminary anode active material layer by coating and drying the anode slurry on a current collector; and
pressing the preliminary anode active material layer to form an anode active material layer having an electrode density of 1.50 g/cc or more;
wherein a difference between the XRD orientation indexes of the anode active material layer and the preliminary anode active material layer is 6 or less, and
wherein the XRD orientation index is defined as I(004)/I(110), I(004) is a peak intensity corresponding to a (004) plane of the anode active material obtained by an XRD measurement, and I(110) is a peak intensity corresponding to a (110) plane of the anode active material obtained by the XRD measurement.

11. The method of claim 10, wherein the XRD orientation index of the anode active material layer is 8 or less.

12. The method of claim 10, wherein the XRD orientation index of the preliminary anode active material layer is 2 or more.

13. The method of claim 10, wherein the electrode density of the anode active material layer is in a range from 1.50 g/cc to 1.80 g/cc.

14. The method of claim 10, wherein the electrode density of the anode active material layer is in a range from 1.70 g/cc to 1.80 g/cc.

15. The method of claim 10, wherein a sphericity of the natural graphite particles is in a range from 0.88 to 0.99.

16. The method of claim 10, wherein the preparing the anode slurry comprises forming an amorphous carbon layer on surfaces of the natural graphite particles.
